(19) United States
(12) Patent Application Publication
(10) Pub. No.: US 2002/0099611 A1
(43) Pub. Date: Jul. 25, 2002

(54) Formation of horizontal, vertical and diagonal databases in an extranet based e-commerce platform

(76) Inventors: Celso Candido De Souza, Curitiba (BR); Francisco Rodolfo Eduardo Pesserl, Curitiba (BR); Stephen Douglas Merry, Moorpark, CA (US)

Correspondence Address: RABIN & CHAMPAGNE, PC, 1101 14TH STREET, NW, SUITE 500, WASHINGTON, DC, 20005, US

(21) Appl. No.: 09/730,479

(22) Filed: Dec. 6, 2000

Related U.S. Application Data
(63) Continuation-in-part of application No. 09/652,568, filed on Aug. 31, 2000.
(60) Provisional application No. 60/169,329, filed on Dec. 6, 1999.

(51) Int. Cl. G06F 17/60

(52) U.S. Cl. 705/26

(57) ABSTRACT

Performing electronic commerce on an extranet-based e-commerce platform. A custom enterprise site is created for each extranet-based e-commerce platform client. A custom extranet is created for each client comprising a subset of buyers and/or sellers from the set of buyers/sellers participating on the extranet-based e-commerce platform. A sales catalog is created and maintained within a sales transaction area of each custom enterprise site. Sales transactions are initiated in the sales transaction area of a custom enterprise site and transmitted over the custom extranet. A purchasing catalog is created and maintained within a purchasing transactions area of each custom enterprise site. Purchasing transactions are initiated in the purchasing transaction area of a custom enterprise site and transmitted over the custom extranet. Fees based of specific transactions are logged and billed to each extranet-based e-commerce platform client. Providing a method for linking clients in an extranet based e-commerce platform in which clients are linked based on multiple criteria and electronic transaction templates corresponding to one or more attributes of the clients are linked to allow similar transaction templates to be used between similar clients.

The present application is a Continuation-In-Part (CIP) of U.S. patent application Ser. No. 09/652,568 filed on Aug. 31, 2000, which claims the priority of U.S. Provisional Patent Application No. 60/169,329, filed on Dec. 6, 1999. All of the aforementioned applications are herein incorporated by reference, but are not admitted to be prior art.

### BACKGROUND OF THE INVENTION

The business-to-business (B2B) market in the United States had total sales, on-line and off-line combined, of $114 billion in 1999 according to a November 1999 Goldman Sachs industry estimate. The B2B market is projected to grow to approximately $1.3 trillion in total sales by 2004 according to Forrester research. In 1999 approximately 1.1% of total B2B sales were e-commerce enabled according to the November 1999 Goldman Sachs industry estimate. A need exists for a method of providing an e-commerce marketplace for the B2B market.

One approach to e-commerce is the enterprise system. In a typical enterprise-based e-commerce system, as shown in FIG. 1, a business entity (110) provides limited access to an existing or custom-created, enterprise network (160) through a firewall (170). Internal users, such as employees (150), and external users such as customer purchasing agents (130) and vendors (140) access the enterprise network (150) through the Internet (100), with access limited by the firewall (170). The firewall (170) comprises software (e.g. code) designed to limit access to a database depending upon passwords and pre-coded access privileges.

This typical enterprise-based, e-commerce system suffers from several deficiencies. First, an enterprise network (160) requires a substantial capital investment for custom software. Second, the enterprise network (160) may have difficulty communicating with potential customers or vendors who utilize protocols, which are incompatible with the enterprise network's proprietary language. Third, the enterprise network (160) requires a potential consumer to separately connect to each potential supplier. If a potential consumer needs to search for a suitable item and wishes to perform a price comparison prior to making an order, multiple rounds of inquiries, each requiring multiple connections, would be required. Fourth, many facets of a normal business relationship must be conducted off-line, including but not limited to negotiating, soliciting bids, and executing a requirements contract.

An alternative to the enterprise-based e-commerce system is an Internet-hosted system for e-commerce, as shown in FIG. 2. In a typical Internet-hosted system for e-commerce, a business entity (110) places information such as a catalog on a host server (200) in the Internet (100) where it is accessible to the public. Potential buyers (130) of the business entity's product or service can typically search a catalog on the host server and, in some cases, place orders. Vendors (140) and employees (150) of the business entity (110) can access the host server (200) for information about the business entity (110).

This typical Internet-hosted system for e-commerce suffers from several deficiencies. First, business content on the host server (200) must generally be manually input. Second, updates to the business content on the host server (200) are generally controlled by the hosting entity and not by the business entity (110) whose content is being hosted. Third, while some automation of the business entity's (110) sales transactions is typical, automation of purchase transactions is not available. Fourth, many facets of a normal business relationship must be conducted off-line, including but not limited to negotiating, soliciting bids, and executing a requirements contract.

Other methods for performing e-commerce have been suggested. However, they are typically variations of one of either the enterprise system or the Internet-hosted system. While these variations frequently address one or more of the deficiencies described, they fail to solve all of these deficiencies.

A need still exists for a method for conducting E-commerce which is not cost prohibitive for small and mid-size businesses, which allows a user to control content and access to the data and functionality available on its extranet, and which provides the functionality to automate and perform a full scope of business transactions, including sales, purchasing, negotiations, requirement contracts, and order and sales tracking. It is an object of the present invention to provide a method for performing e-commerce transactions over an extranet-based e-commerce platform, which requires a minimum capital investment by its users. It is a further object of the present invention to provide a method for performing a full range of business transactions over an extranet-based e-commerce platform. It is yet another object of the present invention to provide a method of performing e-commerce transactions over a custom extranet wherein each user chooses the other users with which it wants to perform e-commerce transactions.

It would also be useful to be able to utilize similarities between clients and, in particular, the industries in which they participate and the products/services that they provide to make for a more efficient e-commerce market place.

### SUMMARY OF THE INVENTION

To achieve these and other objectives, and in view of its purposes, the present invention provides a method for performing a full range of e-commerce transactions over a custom extranet, created on an extranet-based e-commerce platform. The terms user, EBEP user, first EBEP user, client, and EBEP client whenever used herein shall refer to an enterprise which is participating in an extranet-based e-commerce platform. The terms buyer, EBEP buyer, and EBEP purchaser, whenever used herein, shall refer to an enterprise participating in an extranet-based e-commerce platform, who is a purchaser of goods or services in a particular transaction or in relation to another particular user. The terms seller, EBEP seller, vendor, EBEP vendor, and first EBEP vendor, whenever used herein, shall refer to an enterprise participating in an extranet-based e-commerce platform, who is a seller of goods or services in a particular transaction or in relation to another particular user. It should be understood that a buyer in one transaction or in relation to another particular user could also be a seller in a different transaction or in relation to that particular user or a different user.

In one embodiment of the present invention, a method is provided for performing electronic commerce on an extranet-based e-commerce platform. Server-side extranet-based e-commerce software is loaded on one or more Internet servers. Client-side extranet e-commerce software is provided to clients. A custom enterprise site is created by each extranet-based e-commerce platform client. The custom enterprise site is created on an Internet server, and comprises at least an extranet maintenance area, a purchasing transactions area, and a sales transactions area.

A custom extranet is created and maintained within an extranet maintenance area of the enterprise site for each client comprising a subset of buyers and/or sellers from the set of buyers/sellers participating on the extranet-based e-commerce platform. The custom extranet defines the other clients with which each client wishes to perform e-commerce transactions. Since only enterprises with which a particular client wants to perform e-commerce are in that particular client's extranet, product searches are more effective. Also, sensitive information can be placed on the particular client's enterprise site since it will only be accessible to the particular client's business partners. The EBEP may automatically notify a client when a new client is added to their custom extranet.

A sales catalog is created and maintained within a sales transaction area of each custom enterprise site. Sales transactions are initiated in the sales transaction area of a custom enterprise site and transmitted over the custom extranet. The sales transaction area can support a full range of sales transactions including: receiving requests for quotes from buyers within the seller's extranet, creating and sending proposals of sale in response to requests for quotes; negotiating and creating sales contracts; and receiving and tracking purchase orders under the sales contracts created.

A purchasing catalog is created and maintained within a purchasing transactions area of each custom enterprise site. The purchasing catalog can be created by incorporating products from vendor's sales catalogs, automating the product search process. Purchasing transactions are initiated in the purchasing transaction area of a custom enterprise site and transmitted over the custom extranet. The purchasing transaction area can support a full range of purchasing transactions including: creating requests for quotes and directing them to specific vendors within the buyer's extranet; receiving proposals of sale in response to the requests for quotes; negotiating and creating purchasing contracts; and creating and tracking purchase orders under the purchasing contracts created.

Fees can be calculated based on a monthly service fee plus transaction-based fees. Specific transactions can be logged and billed to each extranet-based e-commerce platform client. For example, each transmission of a request for quote, an offer of sale, a contract, or a purchase order could be logged and subject to a transaction fee.

The present invention also provides a method for linking clients in an extranet based e-commerce platform, in which clients are linked based on multiple criteria, and electronic transaction templates corresponding to one or more attributes of the clients are linked to allow similar transaction templates to be used between similar clients. As an example, clients may be organized in a horizontal database according to their ability to provide particular products/services. Alternatively, clients or vendors may be organized according to industry, in which case a vertical database can be formed and the forms, templates and transaction processes used by these vendors linked, and in fact can emanate from one single template.

Diagonal databases can also be created in which case the processes of a particular vendor can be inspected ranging from their materials through their transportation and sales and billing.

The advantage of creating horizontal, vertical and diagonal databases are that it allows for utilization of similar forms thus facilitating electronic commerce, and also provides for a simple and automated way of determining vendors who supply a particular type of product or service within a particular industry or across industries. Similarly, it allows for inspection of how a particular company produces their product/service and allows for the possibility of proposing an alternate product/service to a particular vendor.

It should be understood that both the foregoing general description and the following detailed description are exemplary, but are not restrictive, of the invention.

The features and advantages of an extranet-based e-commerce platform will be more fully understood from the following detailed description of the preferred embodiments, which should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1 illustrates a prior art method of performing e-commerce using the Internet with an enterprise system;

FIG. 2 illustrates a prior art method of performing e-commerce using Internet-based hosting;

FIG. 3 illustrates an Extranet-based E-commerce Platform (EBEP);

FIG. 4 illustrates architecture for an EBEP, according to one embodiment;

FIG. 5 illustrates an EBEP implementation, according to one embodiment;

FIG. 6 illustrates a use diagram for an EBEP, according to one embodiment;

FIG. 7 illustrates a graphical user interface (GUI) of the extranet administration area of the EBEP, according to one embodiment;

FIG. 8 illustrates a GUI of the purchasing transaction area of the EBEP, according to one embodiment;

FIG. 9 illustrates a GUI of the sales transaction area of the EBEP, according to one embodiment;

FIG. 10 is a flowchart illustrating how a user's transaction-based fees are logged on an extranet-based e-commerce platform, according to one embodiment;

FIG. 11 is a flowchart illustrating the function of adding vendors/customers to a first EBEP user's extranet, according to one embodiment;

FIG. 12 is a flowchart illustrating the function of creating a request for quotation, according to one embodiment;

FIG. 13 is a flowchart illustrating the function of creating a sales proposal, according to one embodiment;

FIG. 14 is a flowchart illustrating the creation of a contract, according to one embodiment;

FIG. 15 is a flowchart illustrating a negotiation forum, according to one embodiment;

FIG. 16 is a flowchart illustrating purchase order status management using e-documents, according to one embodiment;

FIG. 17 represents a description of organization of clients/vendors according to industry/service category; and

FIG. 18 illustrates linking between objects/records.

### DETAILED DESCRIPTION OF THE PREFERRED EMBODIMENT

In describing a preferred embodiment of the invention illustrated in the drawings, specific terminology will be used for the sake of clarity. However, the invention is not intended to be limited to the specific terms so selected, and it is to be understood that each specific term includes all technical equivalents that operate in a similar manner to accomplish a similar purpose.

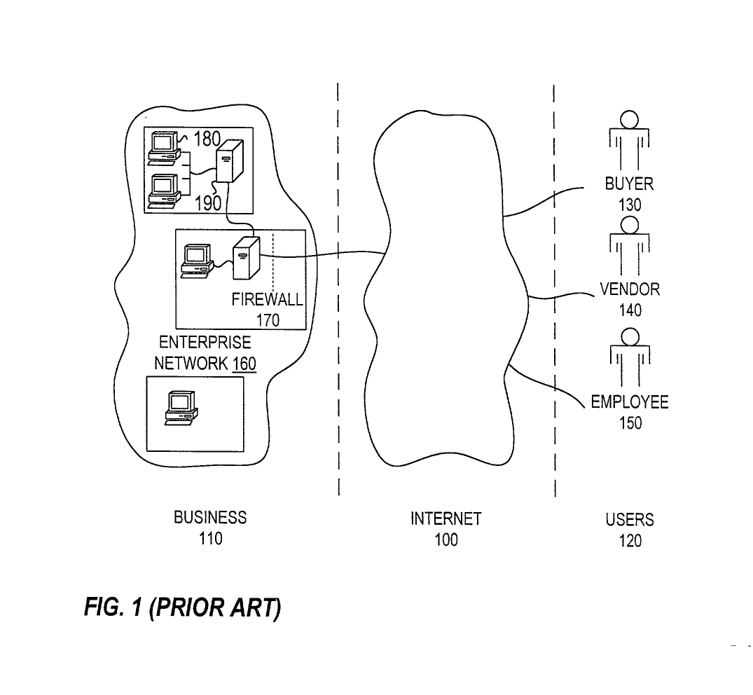

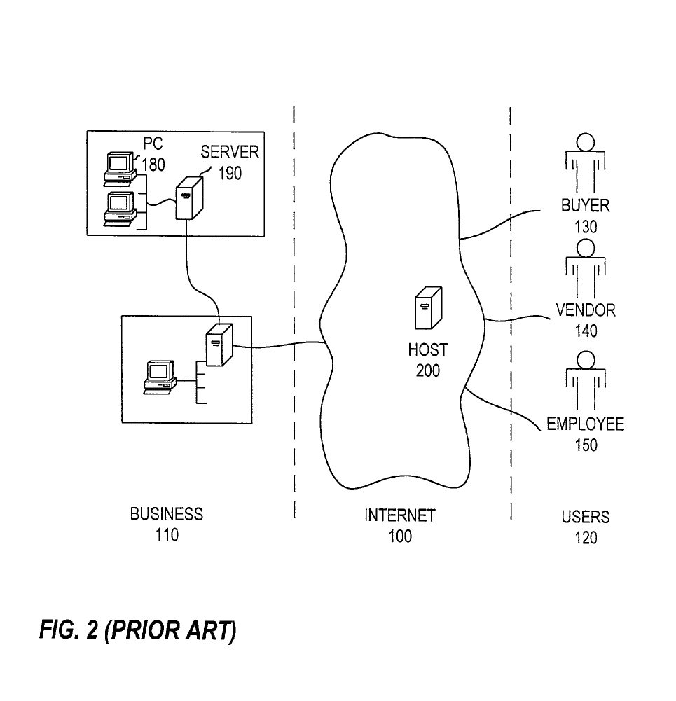

With reference to the drawings, in general, and FIGS. 1 through 18 in particular, the present invention will be described in detail, with reference to the accompanying drawings, in which like reference numerals designate similar or corresponding elements, regions, and portions. The present invention provides a method for performing e-commerce over a custom extranet.

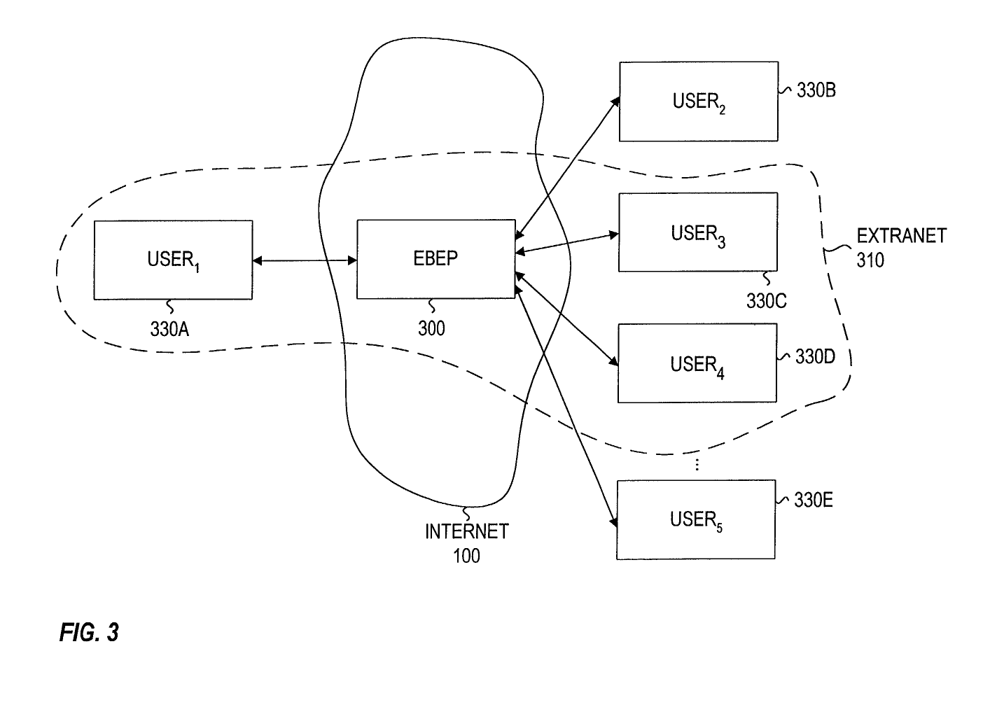

FIG. 3 illustrates an extranet-based e-commerce platform (EBEP), wherein each EBEP user creates a custom extranet. For example, a first EBEP user (330A) of the EBEP (300) creates a custom extranet (310) by selecting other EBEP users (330C, 330D) from the community of EBEP users (330A, 330B, 330C, 330D, 330E). The EBEP users (330C, 330D) in the first user's extranet (310) could be vendors to the first EBEP user (330A), customers of the first EBEP user (330A), or preferably both. When business functions are performed, only the EBEP users (330C, 330D) in the first EBEP user's extranet (310) are involved.

The custom extranet (310) provides several advantages over other e-commerce platforms. By limiting product/service searches to EBEP users that the first EBEP user (330A) wants to transact commerce with (e.g. strategic partners, preferred suppliers, and the like), electronic traffic is reduced, making the EBEP (300) more efficient, and eliminating wasted time sorting through unsolicited and unwanted offers. The custom extranet (310) can also reduce rogue buying within the first EBEP user's (330A) organization. Rogue buying is the purchase of a product or service from a vendor other than the vendor with whom the first EBEP user (330A) has a contract for that product or service. Reducing rogue buying can provide substantial savings.

Another advantage of the custom extranet (310) is that in can help to maintain confidentiality. Only EBEP users (330C, 330D) selected for the first EBEP user's extranet (310) have access to information identified as confidential by the first EBEP user (330A). This can be particularly important when financial information is provided in the custom extranet (310).

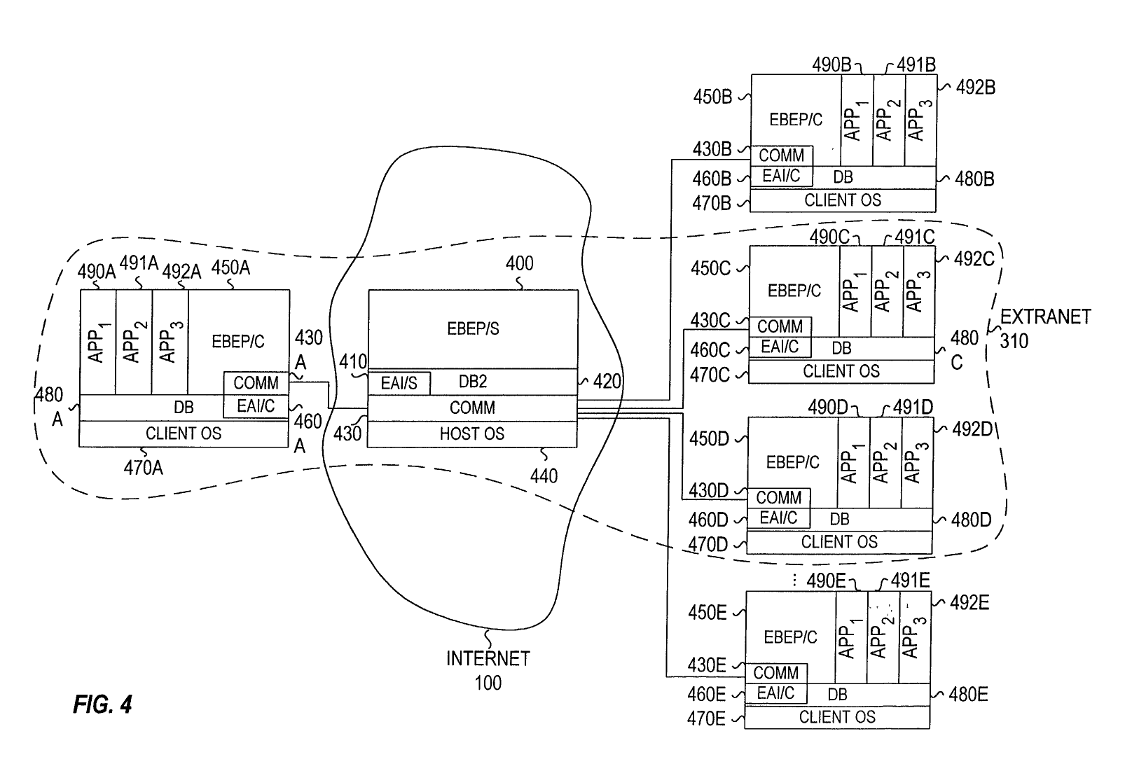

FIG. 4 illustrates an architecture for one embodiment of an EBEP according to the principles of the present invention. The first EBEP user's software comprises a client-side operating system (470A), a first database (480A), user applications (490A, 491A, 492A), extranet-based e-commerce platform software (450), client-side Enterprise Application Integration (EAI) software (460) and communications layer software (430). In the embodiment shown in FIG. 4, the first EBEP user's software communicates through the communication layer (430) to a host server on the Internet (100). The host server software comprises a host operating system (440), a database software (in the example shown in FIG. 4, DB2), server-side extranet-based e-commerce platform software (400), server-side EAI software (410), and communications layer software (430).

The host server is also connected to other EBEP users through the communications layer software (430). The other EBEP users' software comprises client-side operating systems (470B, 470C, 470D, 470E), databases (480B, 480C, 480D, 480E), user applications (490B, 491B, 492B; 490C,491C,492C; 490D, 491D, 492D; 490E, 491E, 492E), extranet-based e-commerce platform software (450), client-side EAI software (460) and communications layer software (430).

It should be understood that the EBEP users would all use the same client-side EBEP software (450), client-side distributed EAI software (460), and the same communications layer software (430). The EBEP users may have the same or different client-side operating software (470), database software (480), and applications software (490, 491, 492). It should be further understood that although the foregoing description is based on a client-server architecture over the public Internet (100), other architectures are possible within the scope of the present invention, as well as, other types of networks.

The client-side EBEP software (450) comprises data entry software. The client-side EBEP software (450) may further include data manipulation for that EBEP user's data. The interactive functions of an EBEP according to the present invention are preferably programmed into the server-side extranet-based e-commerce platform software (400), which is loaded on the server(s) for the extranet-based e-commerce platform. The server(s) preferably use an active server page (ASP) format.

The architecture of FIG. 4 provides a complex relationship between the full databases of multiple parties or enterprises. Instead of merely providing access to the data of one enterprise by other enterprises or individuals, the data from one enterprise can interact with data from another enterprise through EAI and EBEP functionality.

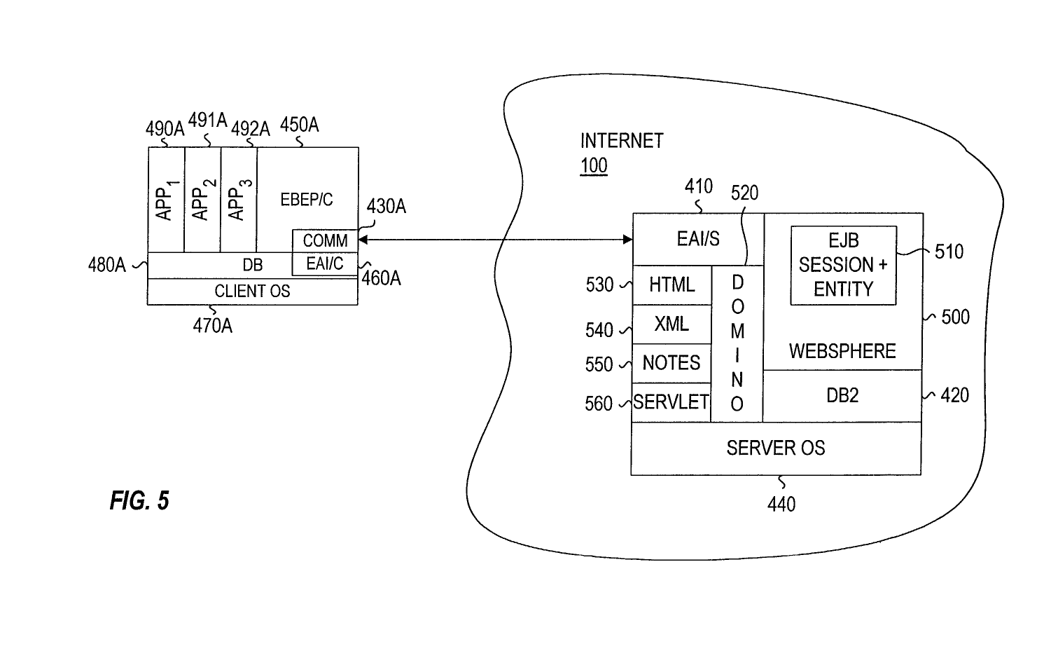

FIG. 5 illustrates an implementation of the EBEP according to one embodiment of the present invention. A first EBEP user connects to a server on the Internet (100). The client side of the connection is essentially the same architecture as shown in FIG. 4. On the server side of the connection, an enterprise java beans architecture (EJB) is used. EJB is a product of Sun Microsystems of Palo Alta, CA. A high-performance open-architecture transaction manager, in this embodiment the Websphere application (500) from International Business Machine, Inc. (IBM) of Armonk, N.Y., may be installed on the server to monitor and manage transactions between enterprises on the EBEP. Although this embodiment uses Websphere as the preferred example, it will be obvious to those of ordinary skill in the art that the invention is scalable so that similar high-performance open-architecture transaction manager applications may be used. In this embodiment, the Websphere application (500) establishes an EJB session/entity (510) associated with the entity (i.e., enterprise) who established it. EJB (510) uses a piece of application code to assemble a working application to perform EBEP functionalities. In an alternate embodiment, NOTES and DOMINO applications may provide basic transaction management for users with smaller traffic requirements.

In a preferred embodiment, the server side EAI software (410) is incorporated using DOMINO (520) by Lotus Development of Cambridge, Mass. DOMINO (520) allows the EJB application to read data in a variety of languages, including hyper text markup language (HMTL) (530), extensible markup language (XML) (540), NOTES (550) by International Business Machines (IBM) and Lotus Development, and SERVLET (560) by Sun Microsystems.

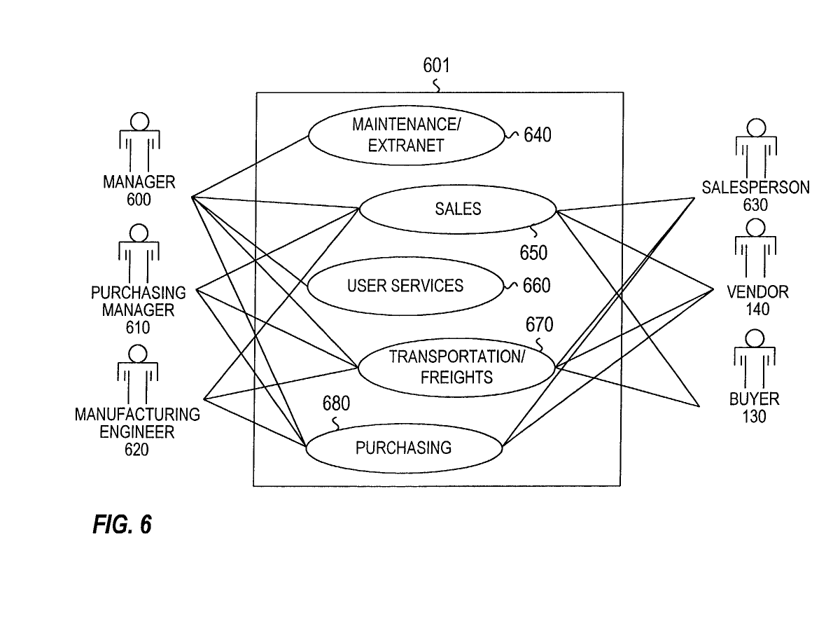

Referring to FIG. 6, each EBEP user creates a custom enterprise site (601) (i.e., an ASP page). The enterprise site (601) comprises an extranet maintenance area (640), a sales transaction area (650) and a purchasing transaction area (680). The enterprise site (601) preferably further comprises a user service area (660) and a transportation transactions area (670). The information in these areas can be private (e.g., only accessible by password) or public (e.g., accessible to any individual at any EBEP user). For example, a list of products/services demanded or offered for sale might be made public in order to encourage increased buying/selling opportunities. Conversely, functionalities such as adding enterprises to a user's custom extranet might be limited to specific individuals within the user's enterprise.

The extranet maintenance area (640) is used to create and maintain a custom extranet (i.e., adding and deleting e-commerce partners and products). The sales transaction area (650) may be used to list products/services for sale, to receive requests for quotes, to make offers of sale, to negotiate and create sales contracts, and to receive and track the status of purchase orders. The purchasing transactions area (680) is used to list products/services demanded by an enterprise, to create and send requests for quotes, to receive offers of sale, to negotiate and create purchasing contracts, and to create, send and track the status of purchase orders. The transportation/freight area (670) can be used to arrange and track transportation or freight of products. The user services area can be used to receive and answer inquiries from other companies, log who is accessing the enterprise site including what areas are accessed and when, locate pages that present problems, view monthly statements for EBEP usage, and provide a history of transactions performed.

In FIG. 6, a first EBEP user (i.e., enterprise) has provided different accesses to various individuals within the enterprise and to other EBEP users within the first EBEP user's extranet. A high-level manager (600) from the first EBEP user has access to the extranet maintenance area (640), and is responsible for creating and maintaining the extranet for the first EBEP user. The high-level manager (600) also has access to the sales transaction area (650), the user services area (660), the transportation/freights area (670), and the purchasing transactions area (680).

A purchasing manager (610) from the first EBEP user has access to the sales transaction area (650). The purchasing manager (610) also has access to the transportation/freight area (670) and the purchasing transactions area (680). A manufacturing engineer (620) from the first EBEP user has access to the sales transaction area (650), the transportation/freight area (670), and the purchasing transaction area (680). A salesperson (630) from the first EBEP user has access to the sales transaction area (650), the transportation/freight area (670), and the purchasing transaction area (680). A vendor to the first EBEP user (140), who is in the first EBEP user's extranet has access to the sales transaction area (650), the transportation/freights area (670), and the purchasing transaction area (680). A buyer of products/services from the first EBEP user (130) has access to the sales transaction area (650) and the transportation/freights area (670).

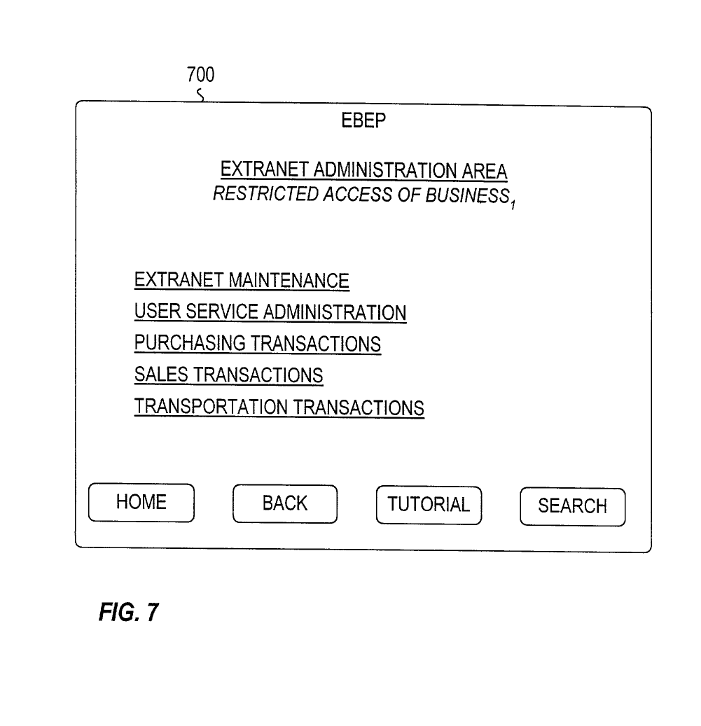

FIG. 7 illustrates a graphical user interface (GUI) for the administration area of a user's enterprise site (700), according to one embodiment of the present invention. When an individual logs onto the enterprise site for his/her enterprise, they enter through the administration area. As shown in FIG. 7, the individual can select a heading corresponding to one of the five areas described above, provided that he/she has the appropriate access. The individual can enter one of these areas by clicking on the corresponding heading to activate a link as is known in the art.

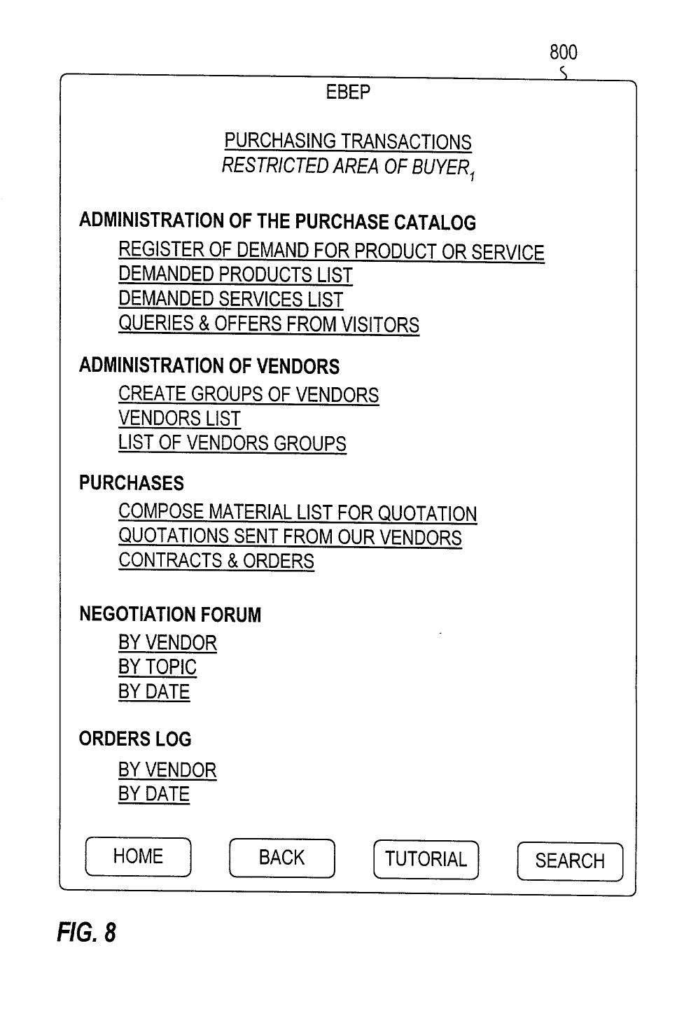

FIG. 8 illustrates a GUI for the purchasing transaction area of a user's enterprise site (800), according to one embodiment of the present invention. As shown in FIG. 8, a comprehensive range of functions related to purchasing transactions can be accessed from within the purchasing transaction area (800). In one embodiment of the present invention, the EBEP functions in the purchasing transactions area are divided into five groupings: administration of the purchasing catalog, administration of vendors, purchases, negotiation forum, and orders log.

In the administration of the purchase catalog grouping, a properly authorized individual can perform administrative functions for the user's purchase catalog. The user's purchase catalog is a listing of the products that a user wishes to purchase. The purchase catalog eliminates the need to search through voluminous catalogs of products which the user does not wish to purchase every time a purchase transaction is performed. Under administration of the purchase catalog, a properly authorized individual can register demand for a product (i.e., add it to the purchase catalog). A properly authorized individual can also access the demanded products list (i.e., purchasing catalog), the demanded services list, or queries and offers from visitors to the public portion of the purchasing transactions area of the user's enterprise site.

In the administration of vendors grouping, a properly authorized individual can perform administrative functions for the user's vendors. Vendor groupings can be created to provide an easy means for identifying vendors for a particular category of products or services. A vendor list identifies all vendors within a user's extranet. A list of vendors groups identifies all of the vendor groupings for a user. These vendor groupings and lists can be created, modified, or viewed, depending upon an individual's access.

In the purchases grouping, a properly authorized individual can compose a material list for quotation. This material list can be manually input based upon the user's needs, such as for the user's manufacturing lines. Alternatively, the materials list can be loaded from an application such as an MRP system. Quotations sent by the user's vendors can be accessed for processing, as will be described in greater detail hereafter. Also, existing contracts and orders can be accessed for tracking, data analysis, or additional orders under an existing contract.

In the negotiation forum grouping of the purchasing transactions area of a user's enterprise site, ongoing and historic negotiations can be accessed by vendor, topic, or date. The negotiation forum will be described in greater detail hereafter.

In the orders log, open and historic orders can be accessed to determine or to update their status. The orders can be accessed by vendor or by date. The orders log function will be described in greater detail hereafter.

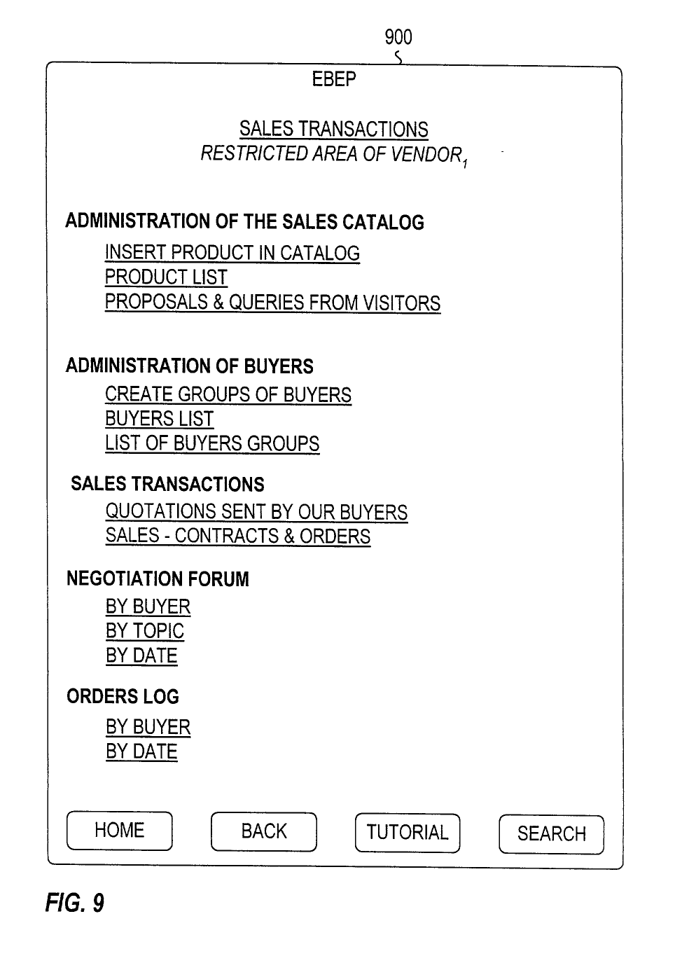

FIG. 9 illustrates a GUI for the sales transaction area of a user's enterprise site (900), according to one embodiment of the present invention. As shown in FIG. 9, a comprehensive range of functions related to sales transactions can be accessed from within the sales transaction area (900). In one embodiment of the present invention, the EBEP functions in the sales transactions area are divided into five groupings: administration of the sales catalog, administration of buyers, sales transactions, negotiation forum, and orders log.

In the administration of the sales catalog grouping, a properly authorized individual can perform administrative functions for the user's sales catalog. The user's sales catalog is a listing of the products that a user wishes to sell. Under administration of the sales catalog, a properly authorized individual can insert a product into the sales catalog. A properly authorized individual can also access the product list or queries and offers from visitors to the public portion of the sales transactions area of the user's enterprise site.

In the administration of buyers grouping, a properly authorized individual can perform administrative functions for the user's buyers. Groupings can be created to provide an easy means for identifying buyers for a particular line of products or services. A buyer list identifies all buyers within a user's extranet. A list of buyer groups identifies all of the buyer groupings for a user. These buyer groupings and lists can be created, modified, or viewed, depending upon an individual's access.

In the sales transaction grouping, a properly authorized individual can access and respond to requests for quotations (RFQs) from the user's buyers (e.g., customers) in the user's extranet. As will be described in greater detail hereafter, an offer of sale (e.g., a quotation) is created in response to an RFQ. Also, existing contracts and orders can be accessed for tracking and data analysis.

In the negotiation forum grouping of the sales transactions area of a user's enterprise site (900), ongoing and historic negotiations can be accessed by buyer, topic, or date. The negotiation forum will be described in greater detail hereafter.

In the orders log, open and historic orders can be accessed to determine or to update their status. The orders can be accessed by vendor or by date. The orders log function will be described in greater detail hereafter.

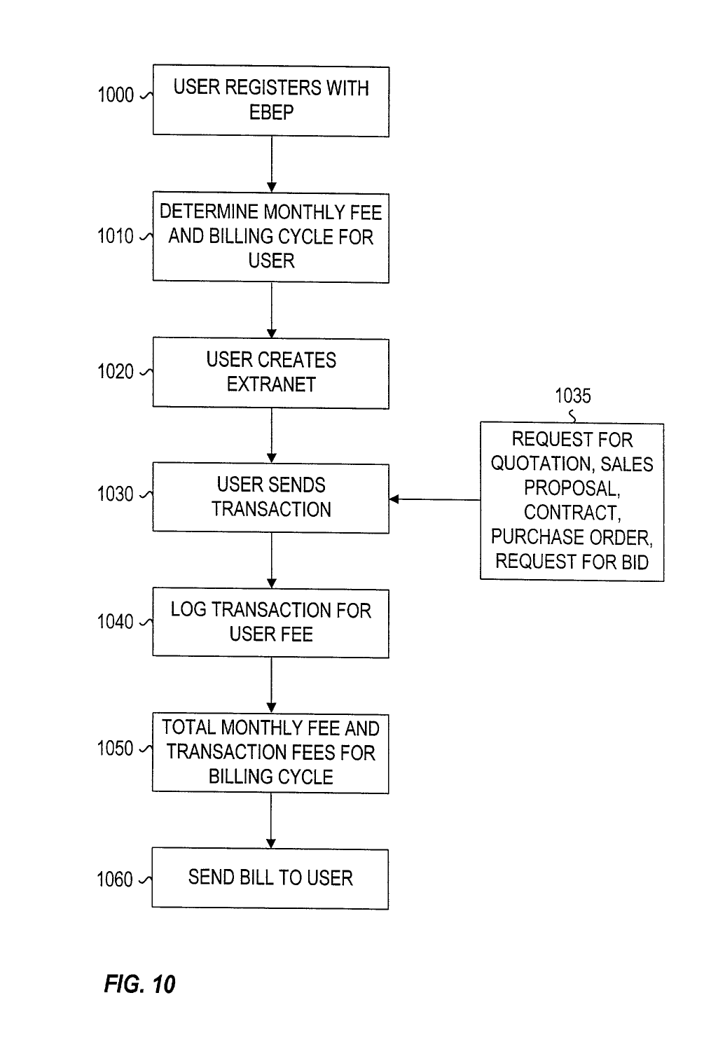

Referring to FIG. 10, in one embodiment of the present invention the EBEP owner collects monthly and transaction-based fees from each EBEP user. When a new user registers with the EBEP (step 1000), the EBEP determines a monthly fee and billing cycle for the new user (step 1010). The new user then creates a custom extranet (step 1020) as will be described in greater detail hereafter. When the user sends transactions which are the basis for fees (step 1030), the EBEP logs the transactions for fee calculation (step 1040). The EBEP owner determines which transactions will be the basis for fees (step 1035). Preferably requests for quotes, sales proposals, contracts, purchase orders, and requests for bid transmissions will be used as a basis for fees. At the end of each billing cycle, the monthly fee and the fees for the transactions are calculated (step 1050), and a bill is sent to the user (step 1060).

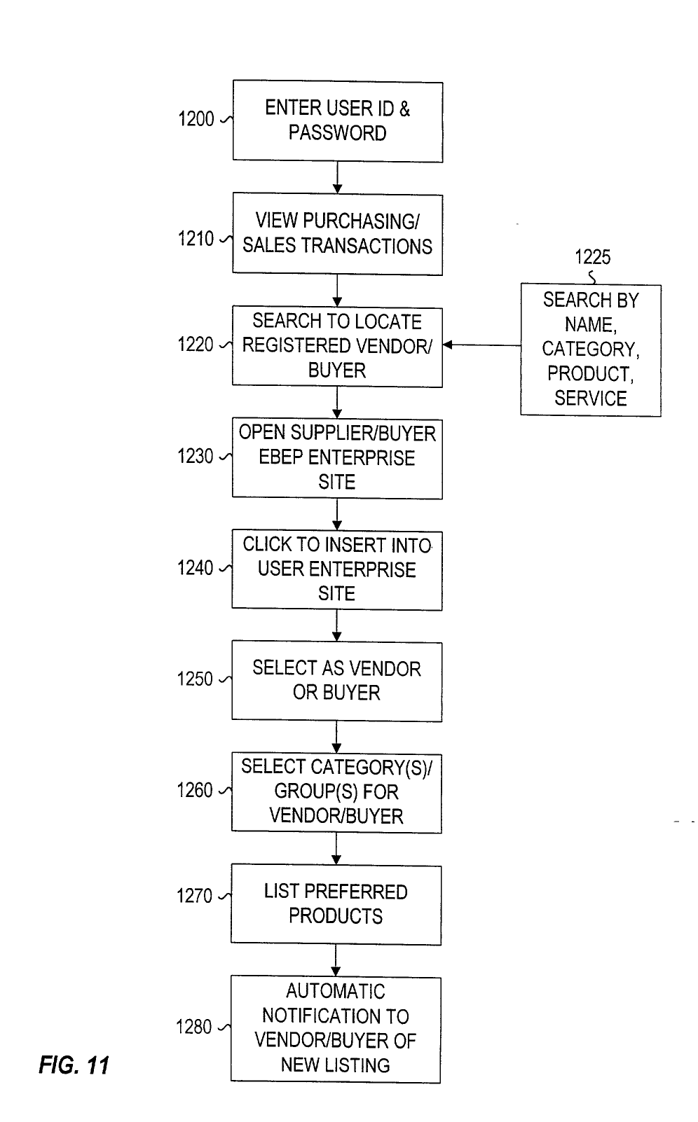

Referring to FIG. 11, new vendors and/or buyers can be added to a first EBEP user's extranet using the purchasing transaction area (680 in FIG. 6) and the sales transaction area (650 in FIG. 6) respectively of the first user's enterprise site. A first authorized individual within the first EBEP user entity logs onto the first EBEP user's enterprise site by entering a user ID and password (step 1200). As can be appreciated by one skilled in the art, the ID and password can be used to limit access to various areas such as purchasing transactions and to various functions within an area such as adding a vendor. This ability enables the first EBEP user's management to operate to a comprehensive business plan, such as the use of preferred suppliers or focused pricing.

In the following description, the transaction for adding a vendor will be illustrated. After the first authorized individual is logged onto the custom extranet, he/she selects the purchasing transaction area (step 1210). Next, he/she selects a search to locate a registered vendor (step 1220). As shown in FIG. 11, the search can be performed by vendor name, vendor category, or product (step 1225).

Once the vendor to be added to the custom extranet has been identified, the selected vendor's EBEP enterprise site is opened (step 1230) and inserted into the first EBEP user's enterprise site (step 1240). This step will download data from the prospective vendor's enterprise site to the first EBEP user's enterprise site. The first authorized individual can then select to add the vendor to the first EBEP user's extranet (step 1250). This step will create a link from the first EBEP user's enterprise site to the new vendor's enterprise site.

Once the new vendor has been selected, the first authorized individual selects the category(s) and/or group(s) that he/she wants the new vendor to appear under (step 1260). For example, if the first EBEP user assembles personal computers and the new vendor manufactures power supplies, then the vendor might be placed in a category for product line components and a category for power supplies. The new vendor might also be placed in a category for preferred pricing or preferred quality vendors. Then, the first authorized individual selects preferred products (step 1270), which the first EBEP user might choose to purchase. The products selected are added to the buying area of the first EBEP user's enterprise site. When the first EBEP user determines that products from multiple vendors meet the specifications of an item in its purchasing area, the multiple vendors can be listed for the product. As shown in FIG. 11, the EBEP software automatically notifies the new vendor of its listings in the first EBEP user's enterprise site (step 1280).

By repeating this procedure for different vendors, the first EBEP user creates a purchasing catalog comprising all of the products (and services) that the first EBEP user purchases during the course of its business. The purchasing catalog identifies each vendor that the first EBEP user has selected to provide each product. The purchasing catalog enables an EBEP user to automate a significant portion of the procurement process, reducing labor and cycle time.

It should be noted that while the foregoing description is directed to adding a vendor, a purchaser can be added to a sales catalog in the same manner by selecting the sales transaction area instead of the purchasing transaction area and substituting buyer in place of vendor. The resulting sales catalog is similar to an on-line catalog in that it lists all of the products that the first EBEP user offers for sale. However, unlike conventional on-line catalogs, each product in the sales catalog of the present invention is cross-referenced to other EBEP users who have expressed interest in purchasing that product. As will be understood by those skilled in the art, this is a valuable marketing tool.

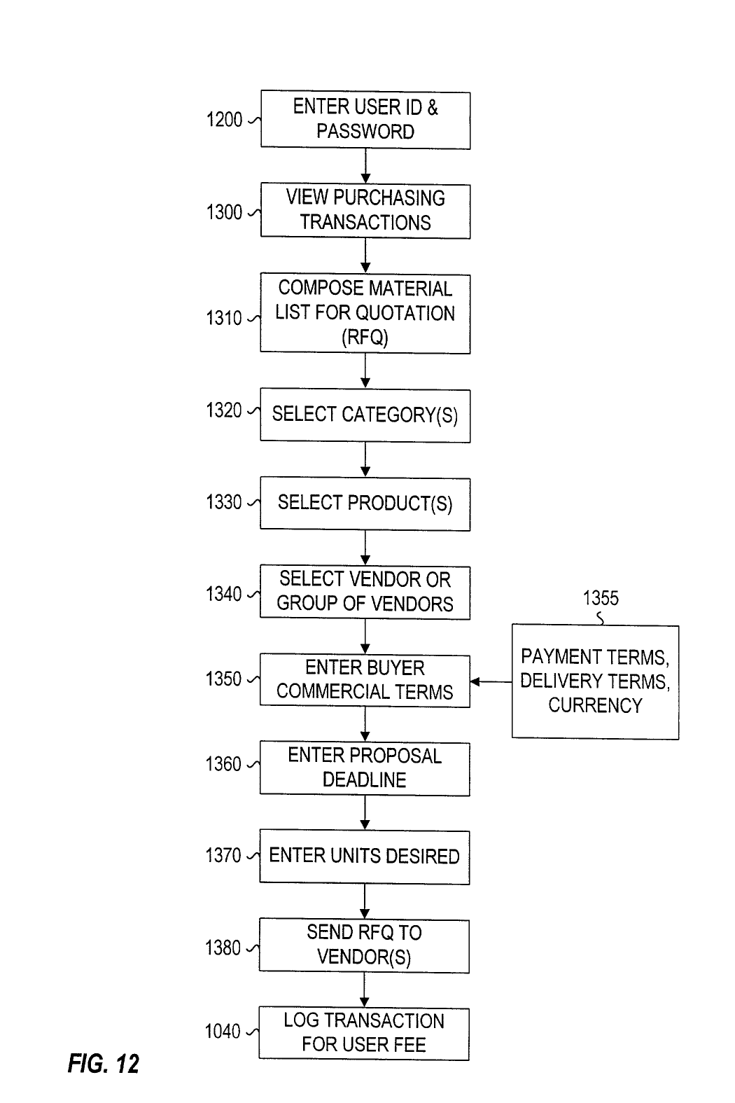

Referring now to FIG. 12, a request for quotation can be created for the first EBEP user in one embodiment of the present invention. After a second authorized individual from the first EBEP user has logged onto the first EBEP user's enterprise site (step 1200), he/she selects to enter the purchasing transaction area of the first EBEP user's enterprise site (step 1300). Then, the second authorized individual composes a material list for quotation (step 1310). The material list can be composed manually or can be uploaded from an integrated material requirement planning (MRP) system.

The second authorized individual selects a category (step 1320) and a product (step 1330) for each item on the material list. It should be noted that the category(s) were determined by the first authorized individual for the first EBEP user when adding each vendor to the first EBEP user's enterprise site, and the products were selected by the first authorized individual from the first EBEP user by selecting them from a vendor's enterprise site, as described above.

The second authorized individual then selects one or more vendors from those vendors listed for each product on the material list or a group of vendors suitable for the particular product. For example, an existing specification for a power supply might have five possible vendors with products determined to meet the specification by the first EBEP user. The second authorized individual may select all five vendors or any combination of them for a request for quote (RFQ). Alternatively, a new power supply may be specified in the material list with no known vendors. The second authorized individual may wish to send an RFQ to each vendor in a group identified as power supply manufacturers.

The second authorized individual enters buyer commercial terms for the RFQs (step 1350). These terms may be preprogrammed for the First EBEP user and automatically entered into the RFQs (step 1355) or they can be custom terms for the RFQ set by the second authorized individual. The terms may include, but are not limited to, considerations such as period for payment, time and method of delivery, and currency. While terms and conditions of a commercial transaction can often be as important or more important than price, conventional e-commerce systems typically offer no flexibility for setting these terms and conditions.

The second authorized individual enters the deadline for receiving sales proposals (step 1360), enters the number of units desired (step 1370), and sends the RFQ to the selected vendor(s) (step 1380).

As illustrated in FIG. 12, sending RFQs is preferably one of the transactions that serve as a basis for a fee. Consequently, the EBEP software logs each RFQ transaction for determination of fees to be charged to the first EBEP user (step 1040).

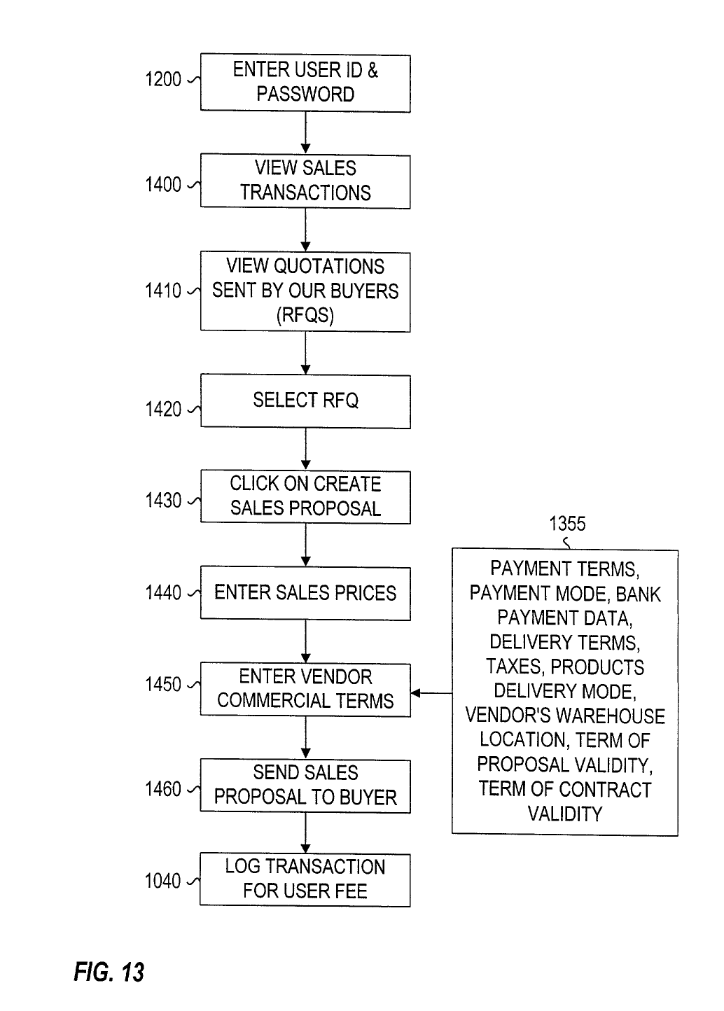

Referring to FIG. 13, the first EBEP user can create sales proposals in response to RFQs received from the first EBEP user's buyers. After a third authorized individual from the first EBEP user is enterprise enters the first EBEP user's enterprise site by entering an ID and password (step 1200), he/she enters the sales transactions area (step 1400) by selecting sales transactions from a menu of areas in the first EBEP user's enterprise site. The third authorized individual then selects view requests for quotations from a menu of functions within the sales transactions area (step 1410). The EBEP software provides a listing of all un-expired and unquoted requests for quotes that have been received from EBEP users who are buyers in the first EBEP user's custom extranet. Preferably each RFQ listing provides a link to its corresponding RFQ document.

The third authorized individual selects an RFQ from the RFQ listing (step 1420). The third authorized individual can then create a sales proposal in response to the selected RFQ. First, he/she selects create sales proposal from a menu of functions available while viewing an RFQ (step 1430). Other functions that might be available include forwarding the RFQ to another authorized individual, “no-quoting” the RFQ, and sending text to the sender of the RFQ to request additional information.

After the third authorized individual chooses to create a sales proposal, he/she enters a sales price (step 1440) and vendor commercial terms (step 1450). The vendor commercial terms may include payment terms, payment mode, bank payment data, delivery terms, taxes, product delivery mode, vendor's warehouse location, term of proposal delivery, term of contract validity, and other terms necessary for completing a sales transaction. These terms may be pre-programmed for the first EBEP user and automatically entered into the sales proposals (step 1355) or they can be custom terms for the RFQ set by the third authorized individual. When sales prices and terms have been entered, the sales proposal is sent to the buyer who had created the RFQ (step 1460).

As shown in FIG. 13, sending sales proposals is preferably one of the transactions that serve as a basis for a fee. Consequently, the EBEP software logs each sales proposal transaction for determination of fees to be charged to the first EBEP user (step 1040).

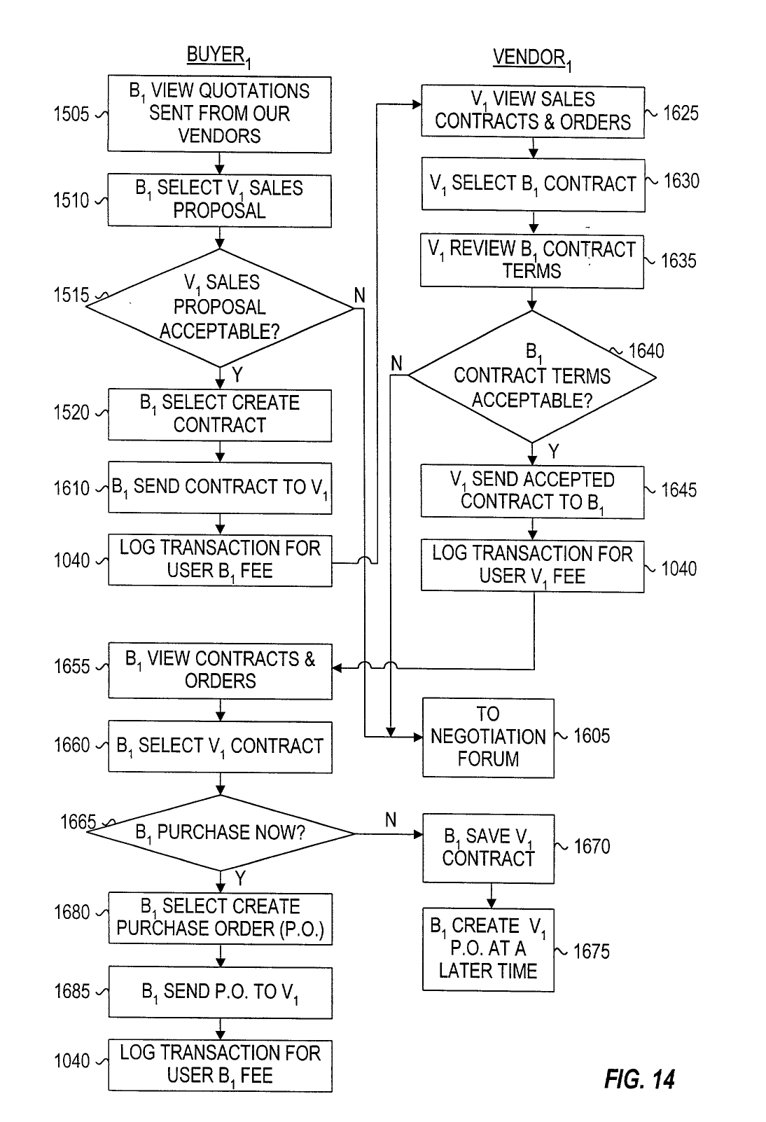

Referring now to FIG. 14, with regard to a particular transaction for a specific product, an EBEP buyer for that transaction (i.e., the EBEP user who created the RFQ for the particular transaction) can create a contract with an EBEP vendor for that transaction (i.e. any of those EBEP users who have responded to the RFQ with a sales proposal). An authorized individual from the EBEP buyer enterprise selects view quotations from the purchasing transaction area of the EBEP buyer's enterprise site (step 1505). The EBEP software responds by providing a list of sales proposals.

The authorized individual from the EBEP buyer selects a sales proposal from a first EBEP vendor from the list of sales proposals (step 1510). After reviewing the sales proposal, the authorized individual from the EBEP buyer determines whether the sales proposal is acceptable (step 1515). If the sales proposal is not acceptable, then he/she selects negotiation forum from a menu of functions (step 1605). The negotiation forum function will be described below. If the sales proposal is acceptable, then the authorized individual from the EBEP buyer selects create a contract from a menu of functions (step 1520). He/she sends the contract to the first EBEP vendor (step 1610).

As illustrated in FIG. 14, sending a contract is preferably one of the transactions that serve as a basis for a fee. Consequently, the EBEP software logs each contract transmission for determination of fees to be charged to the EBEP buyer (step 1040).

When an authorized individual from the first EBEP vendor enterprise selects view sales contracts and orders from a menu in the sales transaction area of the first EBEP vendor's enterprise site (step 1625), the contract from the EBEP buyer appears on the listing of sales contracts and orders. The authorized individual from the first EBEP vendor selects the contract from the EBEP buyer from a listing of contracts and orders (step 1630), and views the contract (step 1635).

After reviewing the contract, the authorized individual from the first EBEP vendor determines whether the contract is acceptable (step 1640). If the contract is not acceptable, then he/she selects the negotiation forum from a menu of functions (step 1605). If the contract is acceptable, the authorized individual form the first EBEP vendor sends the contact to the EBEP buyer (step 1645). As described above, sending the contract is preferably one of the transactions that serve as a basis for a fee. Consequently, the EBEP software logs each contract transmission for determination of fees to be charged to the first EBEP vendor (step 1040).

When the authorized individual from the EBEP buyer enterprise selects view contracts and orders from a menu in the purchasing transaction area in the EBEP buyer's enterprise site (step 1655), the contract created above appears on a listing of contracts and orders. The authorized individual from the EBEP buyer can select the contract created above from the listing (step 1660).

The authorized individual from the EBEP buyer determines whether to place a purchase order under the newly created contract, at the present time (step 1665). If he/she decides to place a purchase order presently, then a purchase order is created in accordance with the contract (step 1680) and sent to the first EBEP vendor (step 1685). Sending a purchase order is preferably one of the transactions that serve as a basis for a fee. Consequently, the EBEP software logs each purchase order transmission for determination of fees to be charged to the EBEP buyer (step 1040).

If the authorized individual from the EBEP buyer decides not to place a purchase order at the present time, the newly created contract is saved (step 1670) for creation of purchase order(s) at a later time (step 1675).

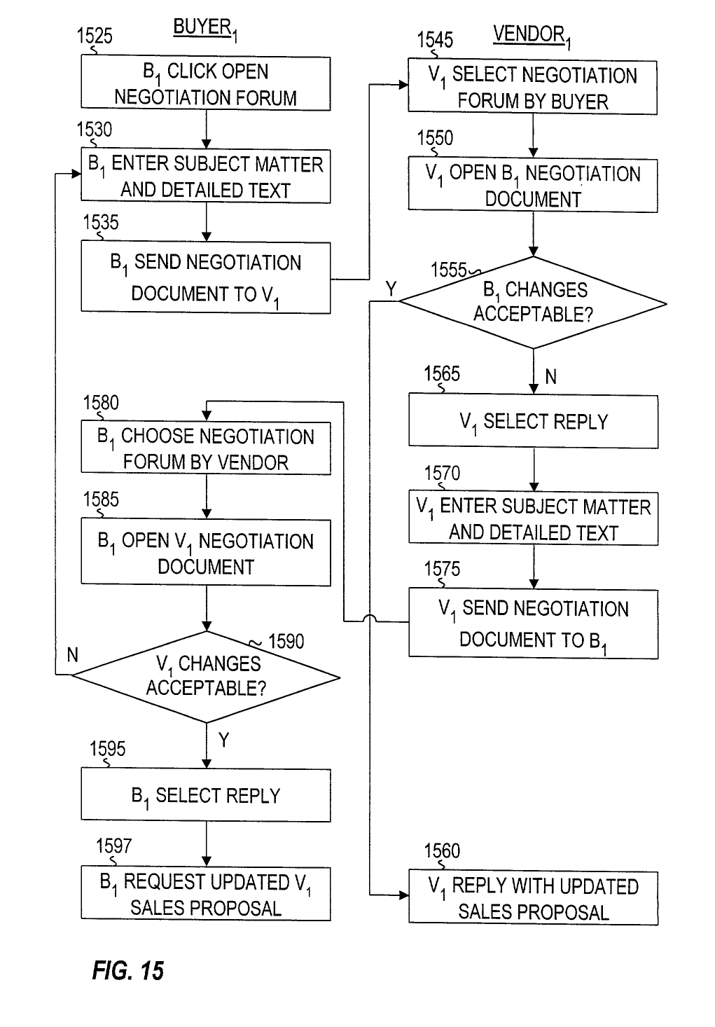

Referring to FIG. 15, with regard to a particular transaction for a specific product or service, an authorized individual from the EBEP buyer for that transaction (i.e., the EBEP user who created the RFQ for the particular transaction) can create a separate private negotiation forum with each EBEP vendor (i.e. those EBEP users who have responded to the RFQ with a sales proposal) or any subset of the EBEP vendors for that transaction.

In response to an unacceptable sales proposal, the authorized individual from the EBEP buyer enterprise can select to open a negotiation forum (step 1525). He/she enters the subject matter and detailed text into a negotiation document (step 1530). The negotiation document is forwarded to the first EBEP vendor (step 1535).

The authorized individual from the first EBEP vendor can select negotiation forum in the sales transactions area of the first EBEP vendor's enterprise site (step 1545). A list of negotiation documents is provided by the EBEP software, including the negotiation document created above by the EBEP buyer. Preferably the list of negotiation documents provides links to the negotiation documents, such that the authorized individual from the first EBEP vendor can open the negotiation document created above by clicking on it in the listing (step 1550).

After reviewing the negotiation document, the authorized individual from the first EBEP vendor determines whether the changes proposed in the negotiation document are acceptable (step 1555). If the changes are acceptable, then he/she responds by sending an updated sales proposal to the EBEP buyer (step 1560). If the changes are not acceptable, then he/she selects reply from a menu of functions (step 1565), enters subject matter and detailed text on the negotiation document (step 1570) and sends the negotiation document back to the EBEP buyer (step 1575).

If the first EBEP vendor sends the negotiation document back to the EBEP buyer (step 1575), it will appear on a listing of negotiation documents. The authorized individual from the EBEP buyer can select the negotiation forum from the purchasing area of the EBEP buyer's enterprise site (step 1580). He/she opens the negotiation document by selecting it from the list of negotiation documents (step 1585). After reviewing the negotiation document, he/she determines whether the changes proposed by the first EBEP vendor are acceptable (step 1590). If the changes are acceptable, then the authorized individual from the EBEP buyer selects reply (step 1595), and requests an updated sales proposal incorporating the acceptable changes (step 1597).

If the changes proposed by the first EBEP vendor are not acceptable in step 1590, the authorized individual from the EBEP buyer's enterprise goes to step 1530 (i.e. enter subject matter and detailed text). The EBEP buyer and the first EBEP vendor can continue to send change proposals back and forth until an agreement is reached or they exceed one of the time limits set by the parties. An advantage of the negotiation forum according to the present invention is that a record is made of the negotiation, available only to the participants of the negotiation forum.

In the foregoing description the EBEP buyer initiates the negotiation forum. It should be understood, however, that an EBEP vendor can also initiate a negotiation forum in response to a contract from the EBEP buyer.

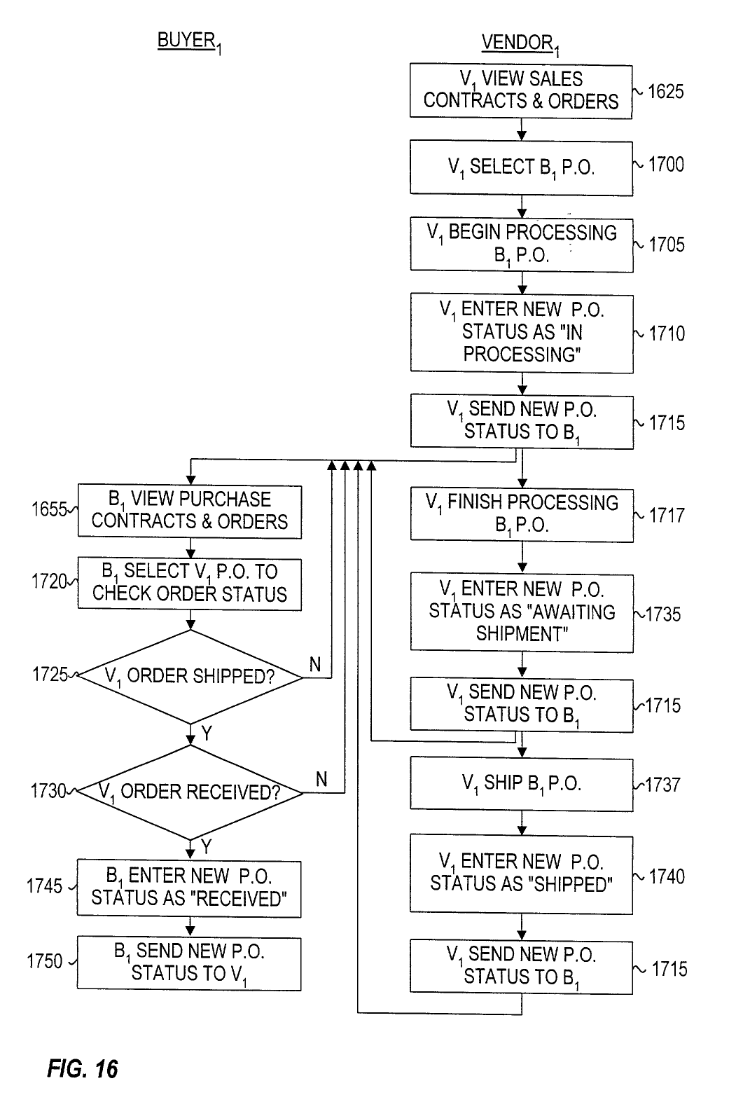

Referring to FIG. 16, an EBEP buyer and a first EBEP vendor can maintain a status record of each purchase order in the contract and order groupings of their purchasing transaction area and sales transaction area respectively. When an authorized individual from the first EBEP vendor selects contracts and orders from the sales transaction area of its enterprise site (step 1625), a listing of open contracts and purchase orders is provided. An authorized individual from the first EBEP vendor can select a first purchase order from the EBEP buyer (step 1700) by activating a link to that purchase order document. An authorized individual from the first EBEP vendor then begins processing the first purchase order (step 1705), enters the new status for the first purchase order as “in process” (step 1710) and sends the new status for the first purchase order to the EBEP buyer (step 1715).

The authorized individual from the first EBEP vendor finishes processing the first purchase order (step 1717), enters the new status for the first purchase order as “awaiting shipment” (step 1735), and sends the new status for the first purchase order to the EBEP buyer (step 1715). When the products required by the first purchase order are shipped (step 1737), an authorized individual from the first EBEP vendor enters the new status for the first purchase order as “shipped” (step 1740) and sends the new status for the first purchase order to the EBEP buyer (step 1715).

When an authorized individual from the EBEP buyer selects contracts and purchase orders from the purchasing transactions area of its enterprise site (step 1655), the first purchase order will appear on the listing of purchase orders. The status of each purchase order can be indicated on the list so that the purchase orders with changed status can be identified.

An authorized individual from the EBEP buyer can select the first purchase order to check its status (step 1720). The authorized individual from the EBEP buyer determines whether the order has been shipped by viewing the status (step 1725). If the product from the first purchase order has not been shipped, then the authorized individual from the EBEP buyer is returned to the purchasing transactions menu. If the product from the first purchase order has been shipped, then the authorized individual from the EBEP buyer is queried whether the product has been received (step 1730). If the product has not been received, then the an authorized individual from the EBEP buyer is returned to the purchasing transactions menu. If the product has been received, then the authorized individual from the EBEP buyer enters the new purchase order status as “received” (step 1745) and sends the new status to the first EBEP vendor (step 1750).

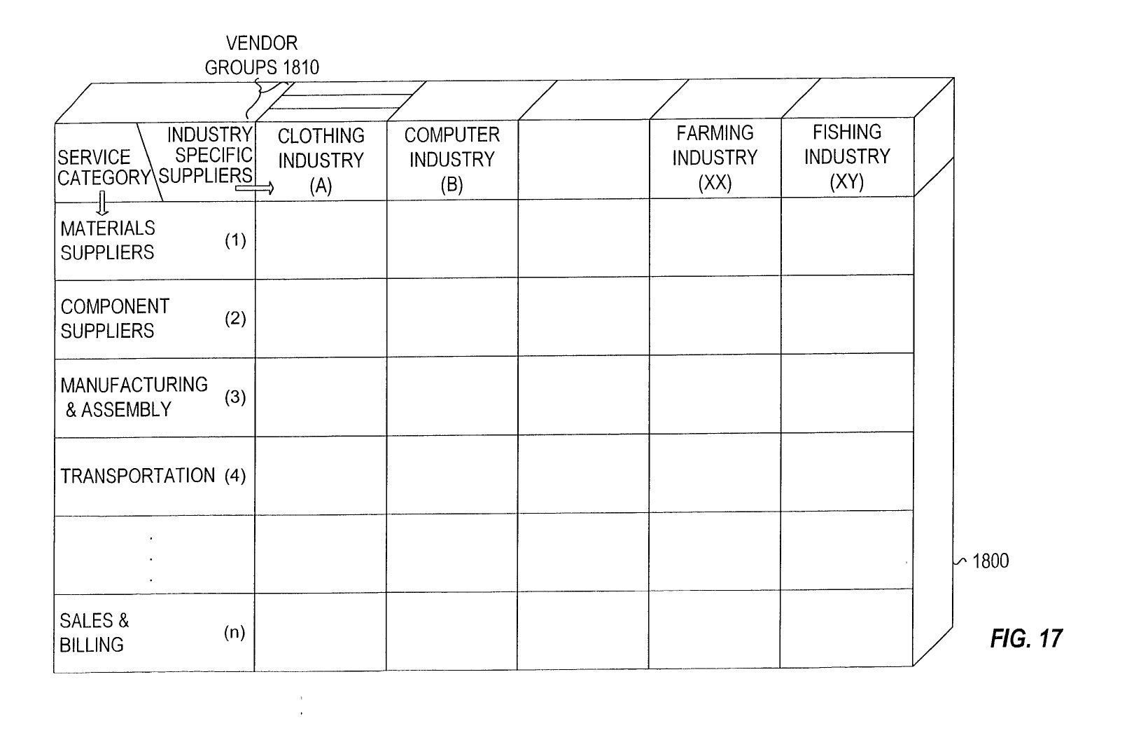

Referring to FIG. 17, organization between clients/vendors is illustrated. In FIG. 17 the horizontal and vertical database architecture 1800 is illustrated according to the use of industry specific denominations in the horizontal direction and service categories in the vertical direction. As illustrated, vendor groups 1810 are formed. As an example, a material supplier to the clothing industry will appear in the database segment falling in the Al position of the matrix. The vendor groups can be considered to lie along a third axis of the architecture. Although shown as a two dimensional set of criteria with vendors extending along the third axis, it will be obvious to those of ordinary skill in the art that multiple dimensions may be used and that the vendors groups may span across any of the axes.

As shown in FIG. 17, if industry specific denominations are used, it may be possible to break the industries down according to those illustrated ranging from the clothing industry, computer industry through various agricultural industries, as well as food supply and manufacturing industries. Other types of industry classifications are possible. As illustrated in FIG. 17, service categories may be given, such as material suppliers, component suppliers, manufacturing and assembly, private transportation through sales and billing. Both the industry denominations and the service categories are examples only and different types of industry classifications or product categories can be utilized. In some instances it will be desirable to break down a particular industry, such as the computer industry, into personal computers, industrial computers and embedded computers. As previously mentioned, this may represent another axis and a whole new set of multiple criteria forming another dimension of the database architecture.

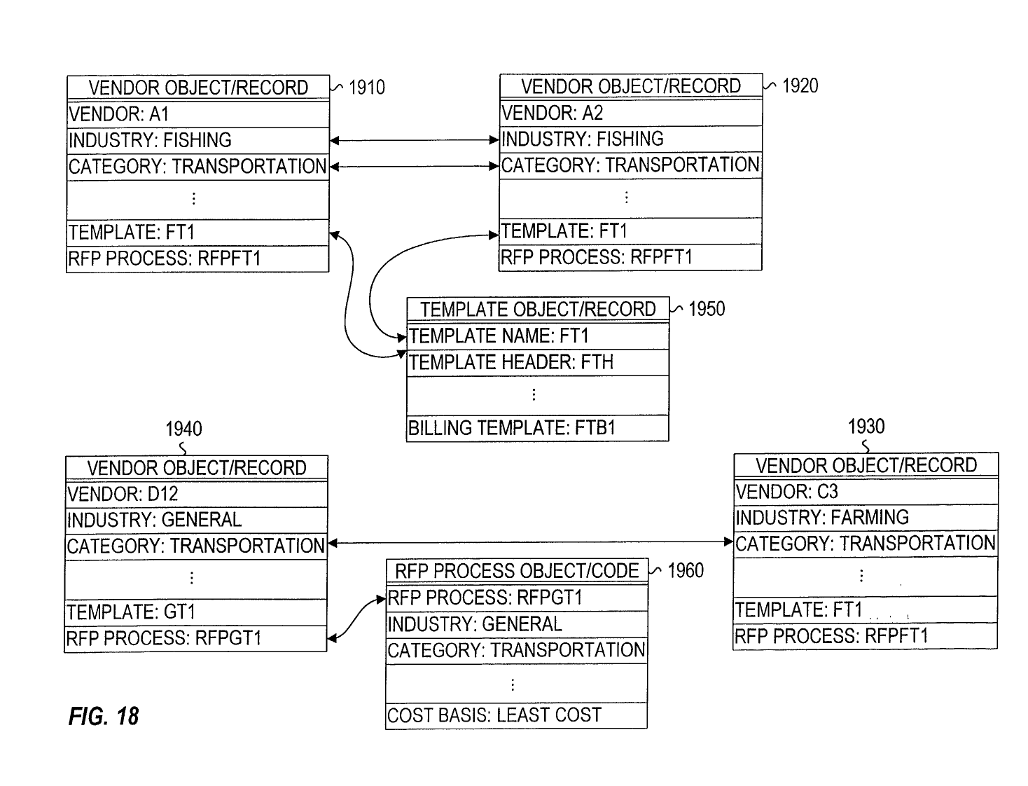

FIG. 18 represents the object/records, which comprise the client or vendor entries as well as templates. These templates may be static templates which provide information regarding the layout of the graphical user interface, or may be part of a process, such as a request for proposal or a response to a proposal. The entries illustrated in FIG. 18 may be objects as part of an object-oriented implementation of an extranet based system or may be records in a database.

As illustrated, a first vendor object/record 1910 contains a vendor identification, an industry classification, a category and a series of templates associated with that vendor. A second vendor object/record 1920 contains some more information and in fact is linked to first vendor object/record 1910 because of identities between the industries. In this example, the industry is fishing and the category is a service category which indicates that the vendor is a transportation service provider to the fishing industry. In both first vendor object/record 1910 and second vendor object/record 1920 the vendors utilize similar templates and RFP processes. The template object/record 1950 is in fact the template that is utilized by the first vendor object/record 1910 and the second vendor object/record 1920, because both vendors fall into the same industry and category they will utilize an identical template, thus eliminating the need for separate templates for these vendors, but providing a template which is specific enough to both their industry and category of service/product that they provide.

Referring to FIG. 18 a fourth vendor object/record 1940 is illustrated. In this case, the vendor falls into a general industry category and provides the transportation service. This category is identical to that of a third vendor object/record 1930, which is a vendor that also provides transportation but more specifically to the farming industry. It can best be seen that although vendors may have several identities between the criteria that are used in the description, that they may have only one criteria which links them. In the case of fourth vendor object/record 1940, that vendor utilizes an RFP processing code RFPGTl which is in fact RFP processing object/code 1960. Although third vendor object/record 1930 and fourth vendor object/record 1940 have one linking they do not utilize the RFP process object/code 1960. It can thus be seen that linking between vendor and the template/processes that they utilize may be extensive or limited. This flexibility allows for identical templates to be utilized when possible but does not constrain a vendor to a particular template.

It can also be understood that processes, such as request for proposals, bids, purchases and other electronic transactions can be described in processes which may be comprised of objects when object-oriented implementations are utilized, or code when procedural programming is utilized.

The invention may be implemented in either an object format or a database format which is relational in nature or another type of database.

The advantages of the present invention can be readily understood in that by organizing vendors/clients according to specific criteria such as an industry or a service category it is possible to share templates or processes. Another possibility is to create linkages such that it is possible to inspect a particular vendor/client. This can occur when the templates or processes used by a particular vendor/client are examined to determine if their processes and templates comply with those desired. As an example, a computer supplier may utilize certain materials purchasing processes, certain types of manufacture/assembly and certain types of transportation. In the extranet based e-commerce platform it is possible to inspect those linkages to determine if that supplier provides their product according to a desired criteria and method.

Because the linking is only made when it is beneficial to the e-commerce, no artificial linkages and constraints are created, only a benefit in terms of eliminating redundant templates and processes, and providing for commonality when it is desired.

Although this invention has been illustrated by reference to specific embodiments, it will be apparent to those of ordinary skill in the art that various changes and modifications may be made, which clearly fall within the scope of the invention. The invention is intended to be protected broadly within the spirit and scope of the appended claims.

What is claimed is:

1. A method for linking clients in an extranet based electronic commerce platform, the method comprising:
organizing clients based on a set of multiple criteria, wherein one or more attributes of the client are stored as part of a client identifier;
creating electronic transaction templates corresponding to one or more attributes of the set of multiple criteria; and
linking the electronic transaction templates to clients based on identities between attributes in the client identifiers and in the electronic transaction template.

2. The method of claim 1, wherein one of the criteria of the set of multiple criteria is an industry identifier.

3. The method of claim 1, wherein one of the criteria of the set of multiple criteria is a product/service category.

4. The method of claim 1, wherein the linking creates a horizontal database of clients providing a particular category of products/services.

5. The method of claim 1, wherein the linking creates a vertical database of clients in a particular industry.

6. The method of claim 1, wherein the linking creates a diagonal database, which provides for inspection of a client's internal processes.
